(19) United States
(12) Patent Application Publication
(10) Pub. No.: US 2011/0305008 A1
(43) Pub. Date: Dec. 15, 2011

(54) CONTAINER HAVING SELF-CONTAINED ILLUMINATION

(76) Inventor: Aja A. Berger, Naples, FL (US)

(21) Appl. No.: 12/940,537

(22) Filed: Nov. 5, 2010

Related U.S. Application Data
(60) Provisional application No. 61/354,357, filed on Jun. 14, 2010.

(51) Int. Cl. F21V 33/00

(52) U.S. Cl. 362/154

(57) ABSTRACT

A system provides illumination in conjunction with a carrying container. The system includes an interior illumination source; a power source; and an actuation device, operatively connected between the interior illumination source and the power source. An actuator operatively engages the actuation device such that the interior illumination source is activated to provide illumination in response to the actuator being operatively engage with the actuation device and independent of an access state of the carrying container.

### PRIORITY INFORMATION

The present application claims priority, under 35 U.S.C. §119(e), from U.S. Provisional Patent Application Ser. No. 61/354,357, filed on Jun. 14, 2010. The entire content of U.S. Provisional Patent Application Ser. No. 61/354,357, filed on Jun. 14, 2010, is hereby incorporated by reference.

### BACKGROUND

Carrying containers come in a variety of shapes, sizes, and descriptions for serving a wide variety of purposes. Examples of carrying containers would include luggage, suitcases, briefcases, attaché cases, backpacks, handbags, pocketbooks, shoulder bags, and/or purses.

A typical carrying container, such as a purse, includes a shell having an exterior, and an interior into which items such as makeup, wallets, pens, documents, money, credit cards, keys and the like can be placed for removal when needed.

In general, a limited opening is provided to enable the user to obtain access to the interior of the purse and a closure device, such as a clamp, clasp, or zipper is used to selectively restrict access through the opening to the interior. A handle or strap may also be provided to enable the user to better manage the carrying of the purse or baggage.

The term “carrying container,” as used herein, refers generally to; but not limited to luggage, suitcases, briefcases, attaché cases, backpacks, handbags, pocketbooks, shoulder bags, and/or purses; containers that fulfill the need of gathering together, carrying, and protecting a variety of useful items.

Notably, a significant difficulty faced by the users of carrying containers is attempting to locate items within the interior of the carrying container. Frequently, the access opening of a carrying container is not sufficiently large to enable an adequate amount of ambient light to illuminate the objects randomly dispersed within the carrying container.

Thus, even when the carrying container is in the wide open position, the light directed into the interior of the carrying container is usually insufficient to illuminate the items piled upon each other inside the carrying container. This is of particular concern when the surrounding available light is substantially diminished due to the absence of sun or artificial light.

It is noted that finding a desired article may require the user to open the carrying container and blindly shuffle through the contents until the form of the desired item is felt. Given this lack of visual acuity, a significant time delay may be encountered when attempting to identify and retrieve an object, which in some circumstances may present a significant concern relative to safety.

Conventionally, the lack of illumination has been addressed by adding a light source inside the bag wherein the light source is activated (turned ON) by the open state of the carrying container or the act of opening the carrying container.

Examples of these conventional devices are set forth in U.S. Pat. No. 7,178,936; U.S. Pat. No. 7,111,959; U.S. Pat. No. 6,848,808; U.S. Pat. No. 6,824,291; U.S. Pat. No. 6,447,142; U.S. Pat. No. 6,120,162; U.S. Pat. No. 5,018,057; and U.S. Pat. No. 3,239,658. The entire contents of U.S. Pat. No. 7,178,936; U.S. Pat. No. 7,111,959; U.S. Pat. No. 6,848,808; U.S. Pat. No. 6,824,291; U.S. Pat. No. 6,447,142; U.S. Pat. No. 6,120,162; U.S. Pat. No. 5,018,057; and U.S. Pat. No. 3,239,658 are hereby incorporated by reference.

Although the conventional devices have provided interior illumination, the actuation of the illumination is dependent upon the open state of the carrying container or the act of opening the carrying container. The tying of the activation of the illumination with the open state of the carrying container or the act of opening the carrying container causes other nuisances and safety issues.

More specifically, a user of a carrying container may want to open the carrying container without disturbing those around, as in a movie theater. With the conventional devices, upon opening the carrying container, the illumination is activated and those around the user may be disturbed by the intrusion of the illumination.

Moreover, a user of a carrying container may want to open the carrying container discreetly, as in the case of the user being stalked by someone and the user does not desire to reveal their location when trying to retrieve a defense device or mobile phone from the carrying container. With the conventional devices, upon opening the carrying container, the illumination is activated and the location of the user may be revealed to the stalker.

Therefore, it is desirable to provide an illumination device having a light emitter, an energy source, and a power interrupter connected therebetween, whereby the light source is activated independently of the open state of the carrying container or the act of opening the carrying container.

Furthermore, it may be desirable to provide an externally actuated switch to selectively operate the light source so that the light source is activated independently of the open state of the carrying container or the act of opening the carrying container.

### BRIEF DESCRIPTION OF THE DRAWINGS

The drawings are only for purposes of illustrating various embodiments and are not to be construed as limiting, wherein:

FIG. 4 is a view of an embodiment of a carrying container in an open state showing a non-activated interior illumination source and an exterior actuator;

FIG. 2 is a view of the embodiment of FIG. 1 wherein the carrying container is in an open state showing an activated interior illumination source and an exterior actuator;

FIG. 3 is a view of the embodiment of FIG. 1 wherein the carrying container is in a closed open state showing an activated interior illumination source and an exterior actuator;

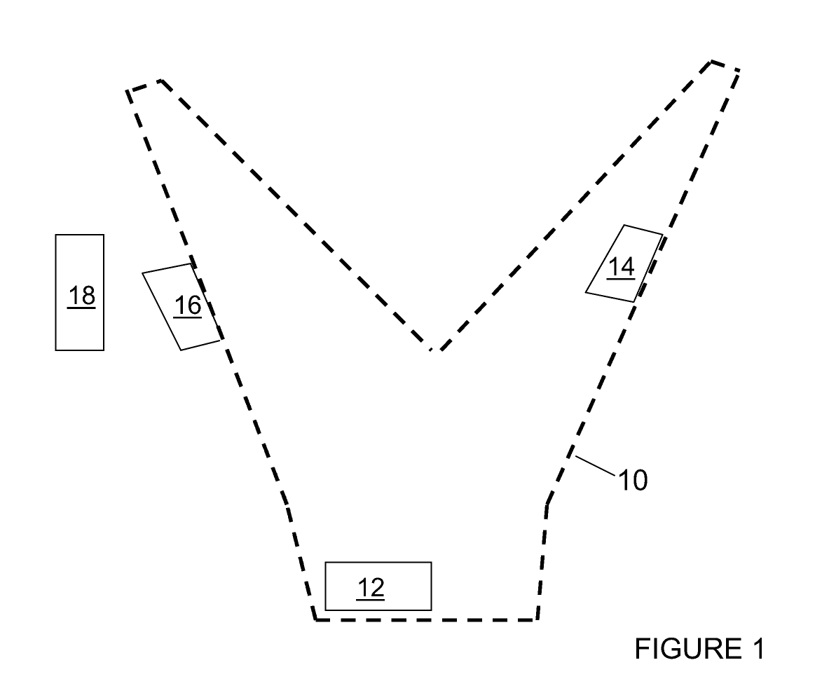

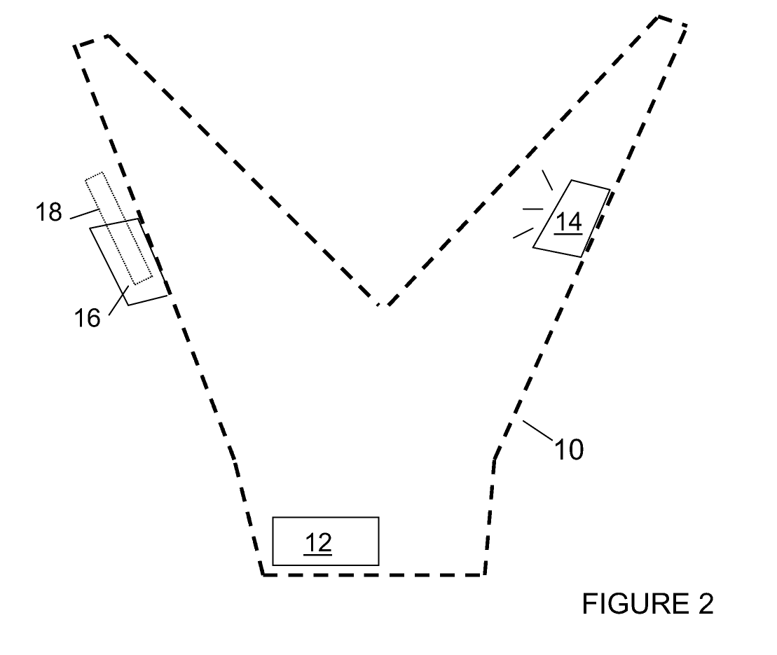

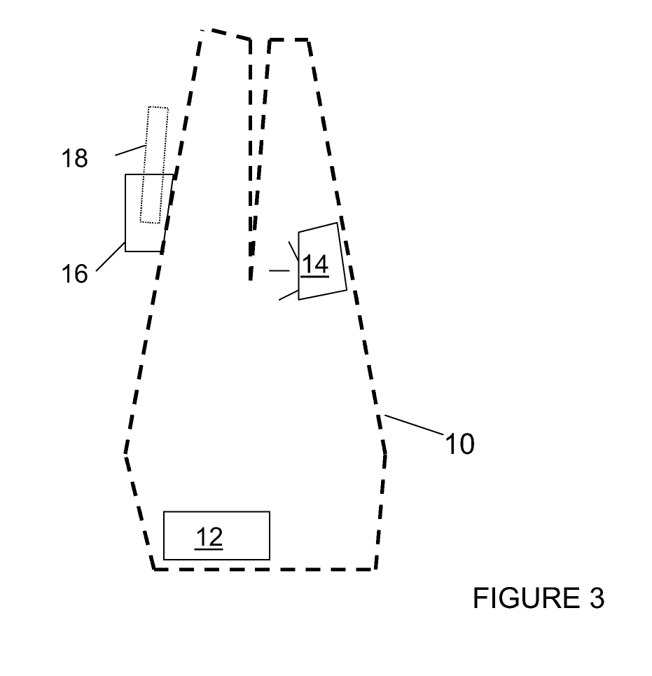

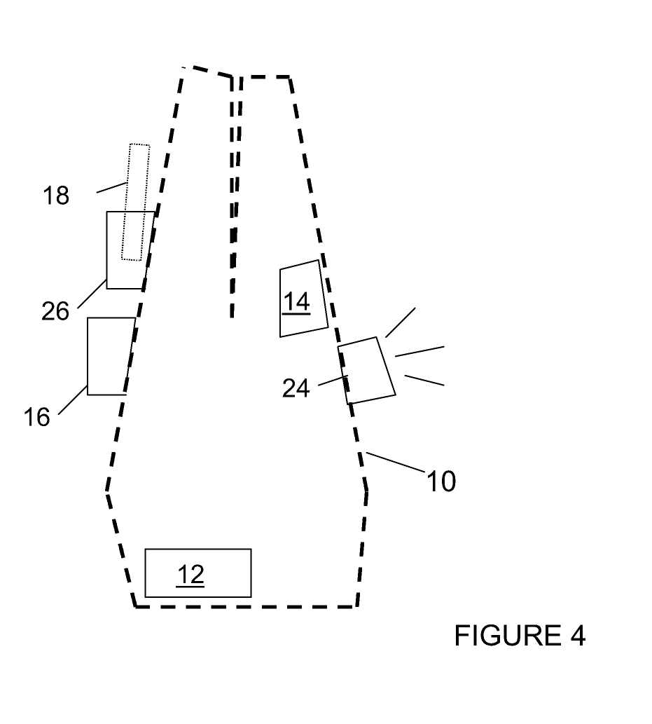

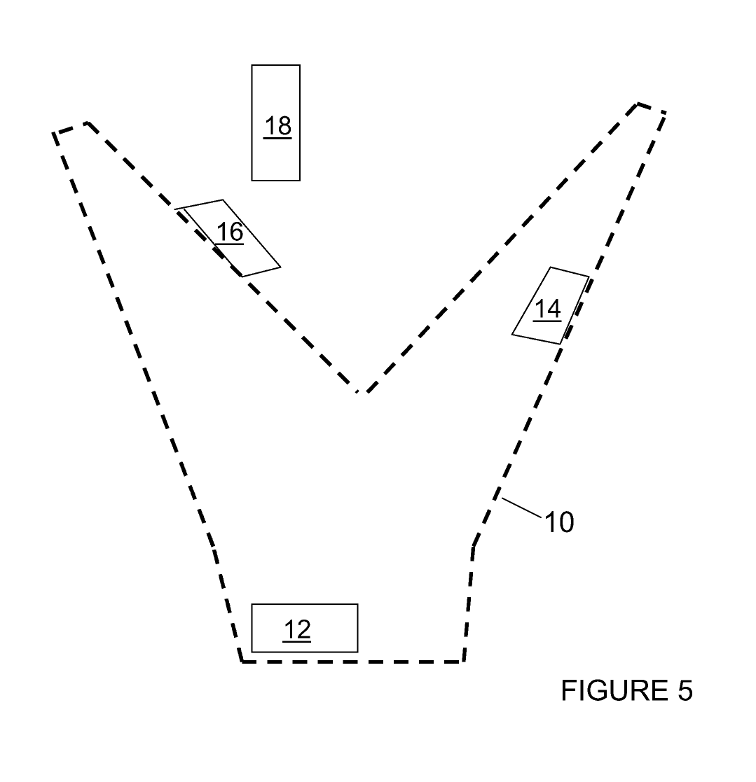

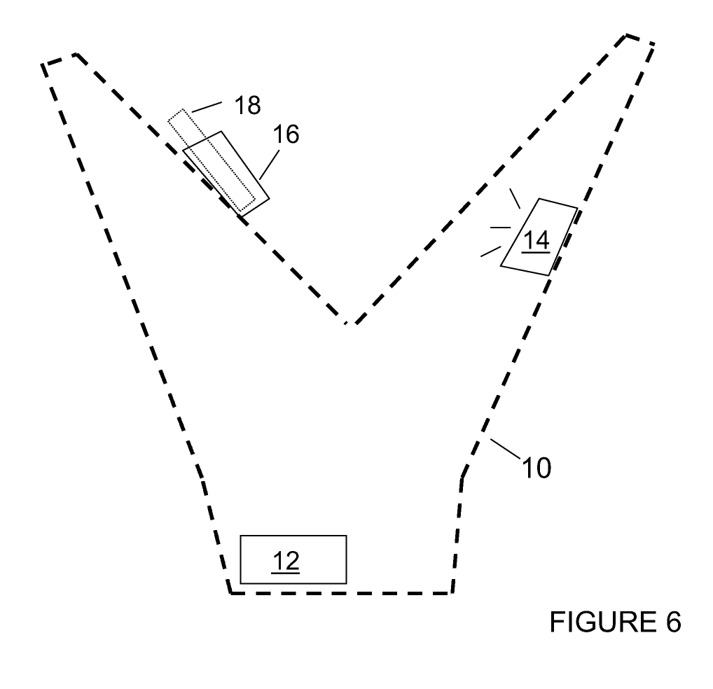

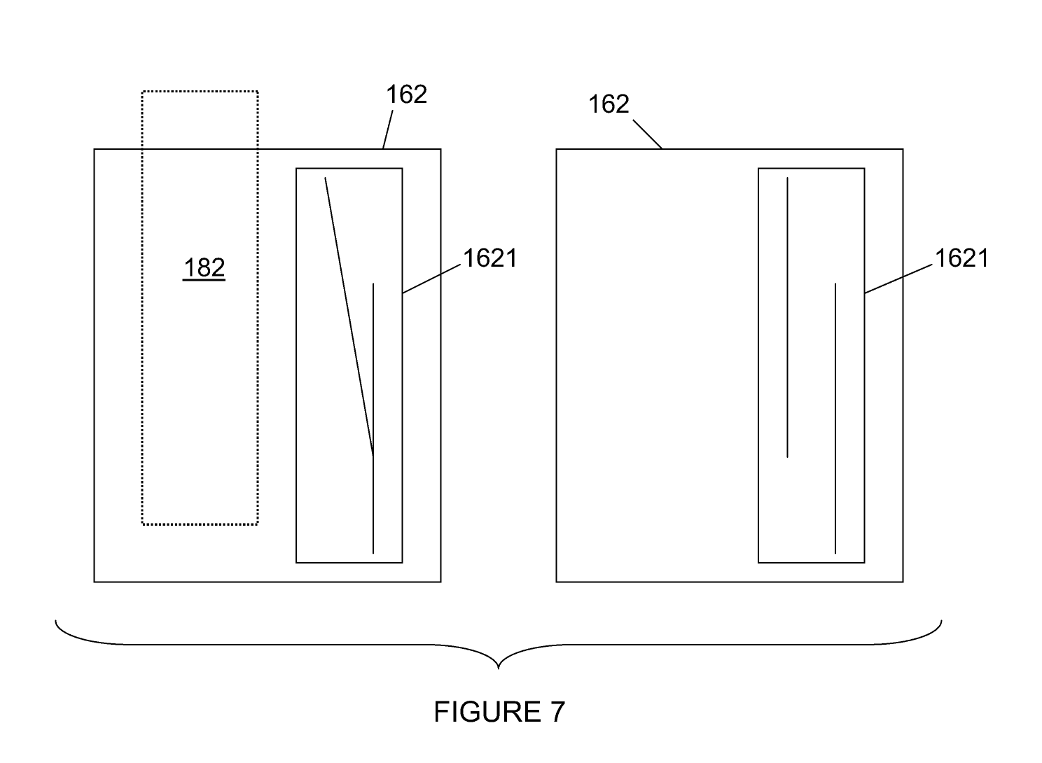

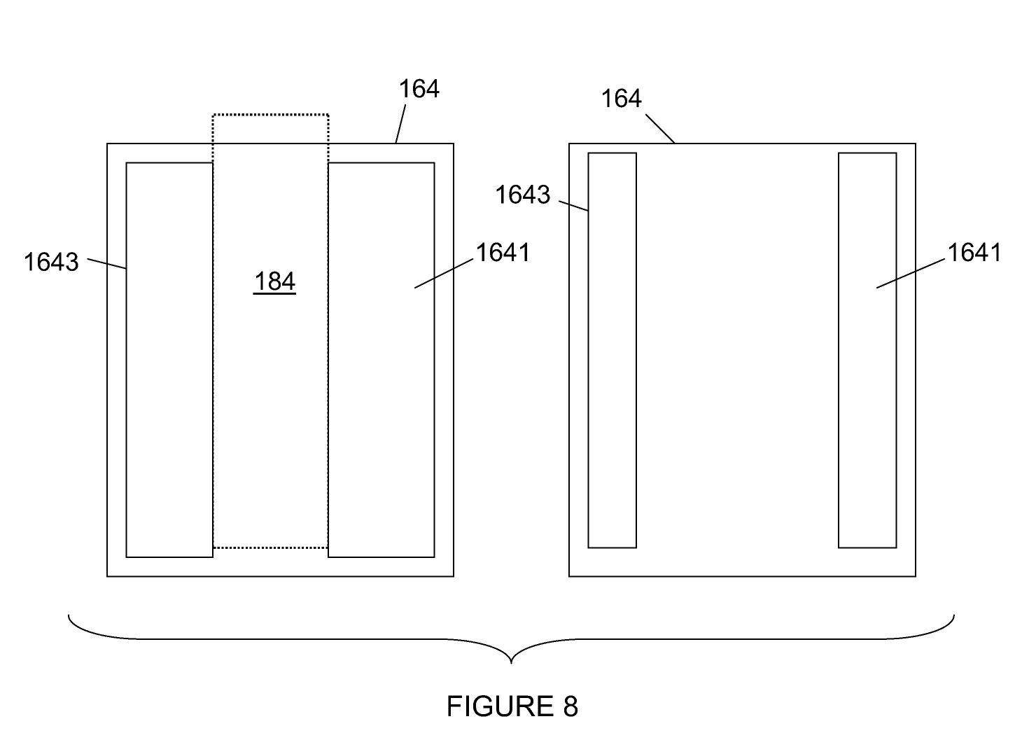

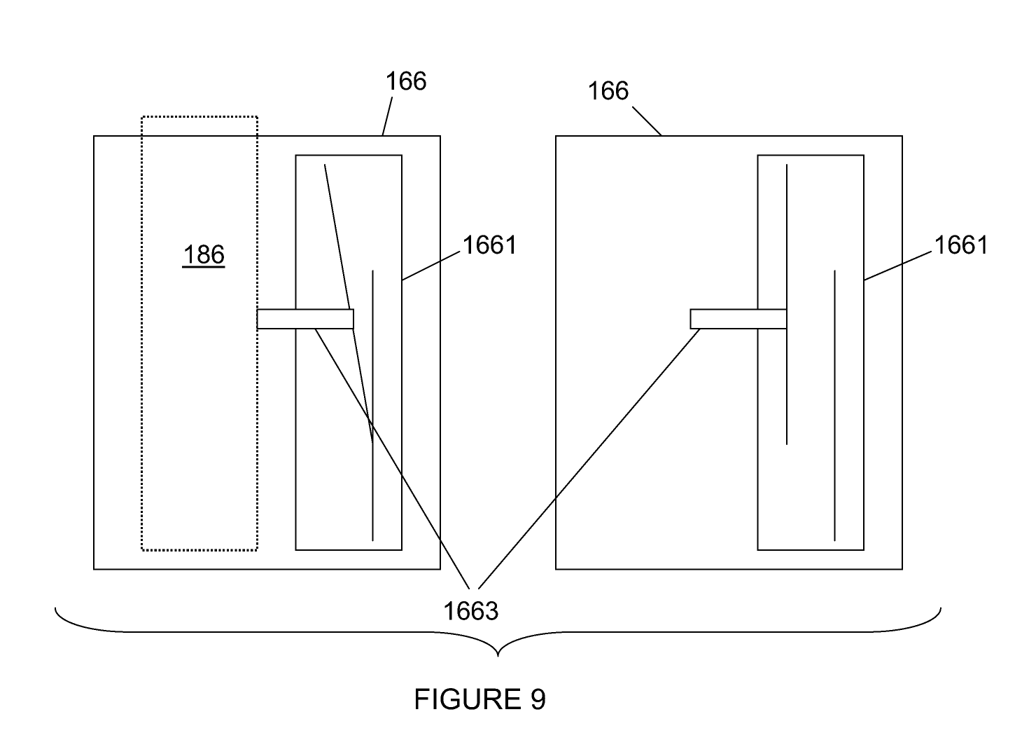

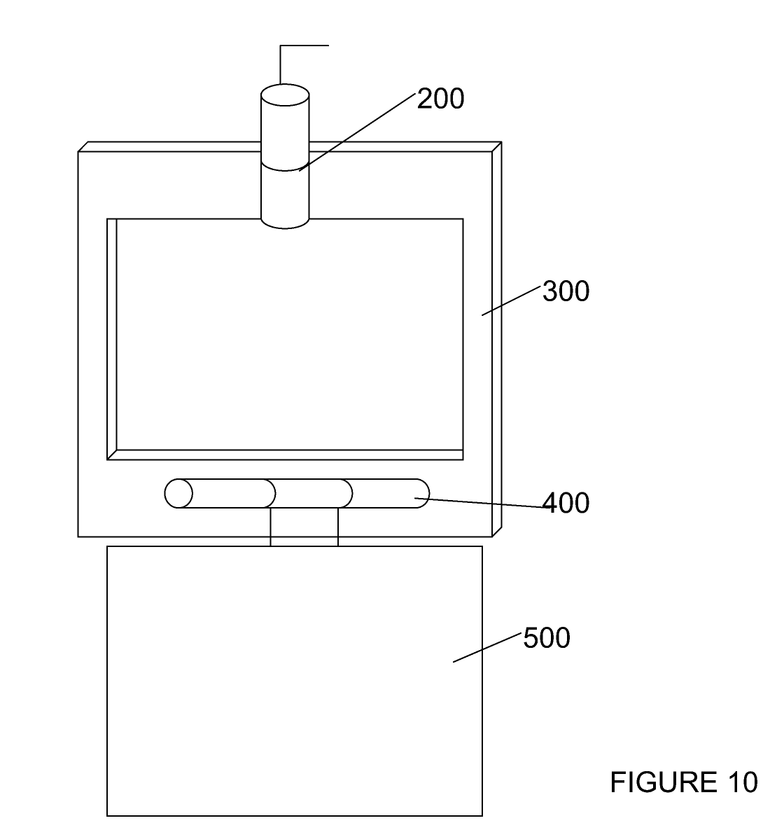

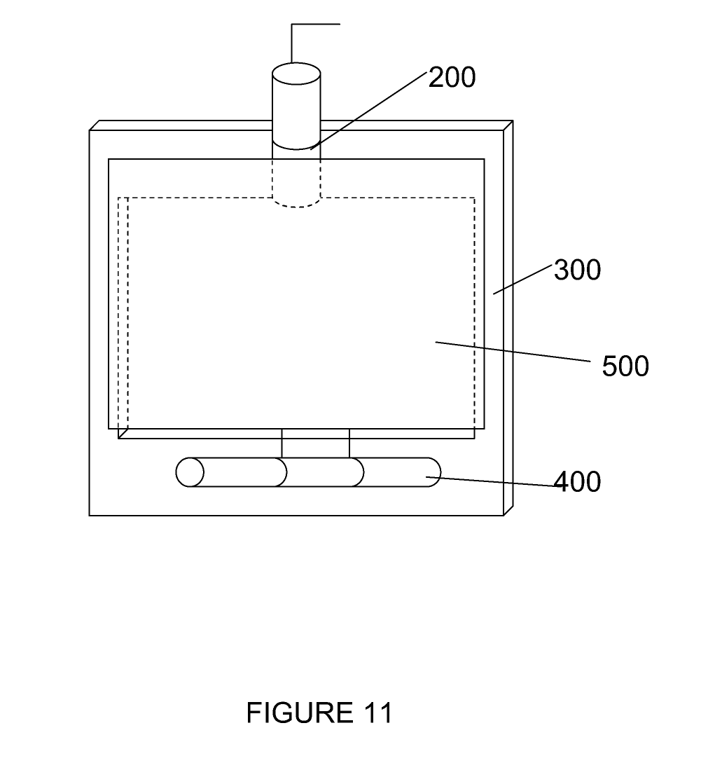

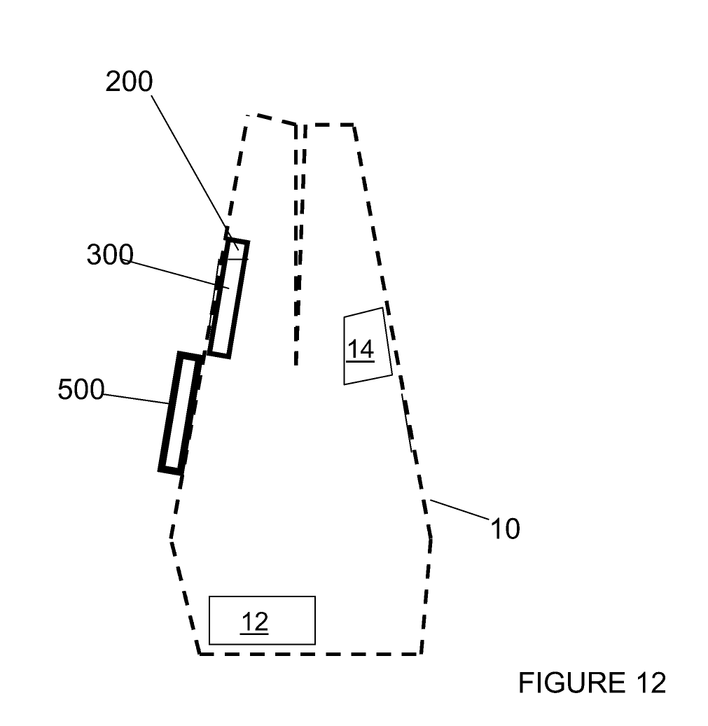

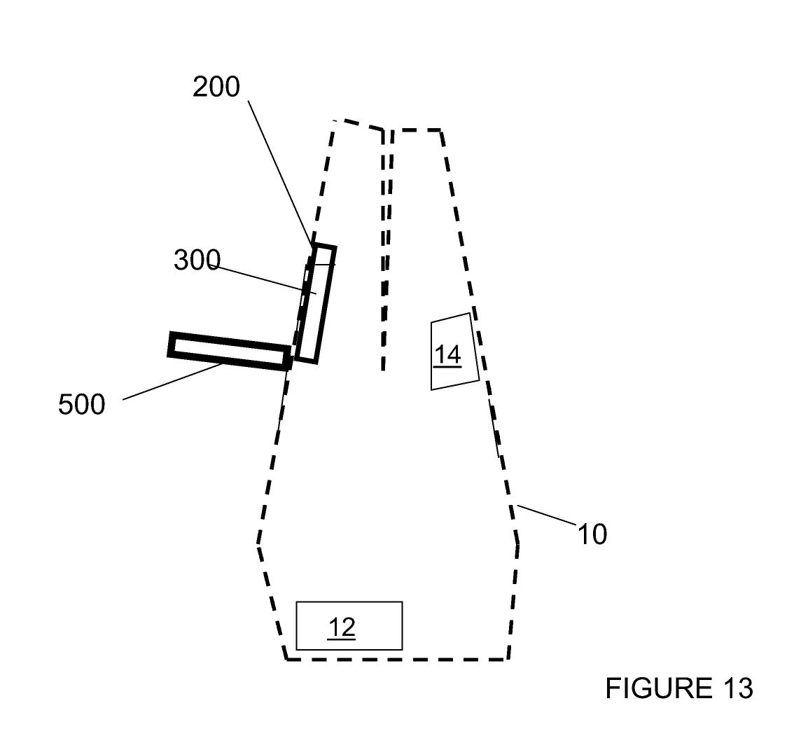

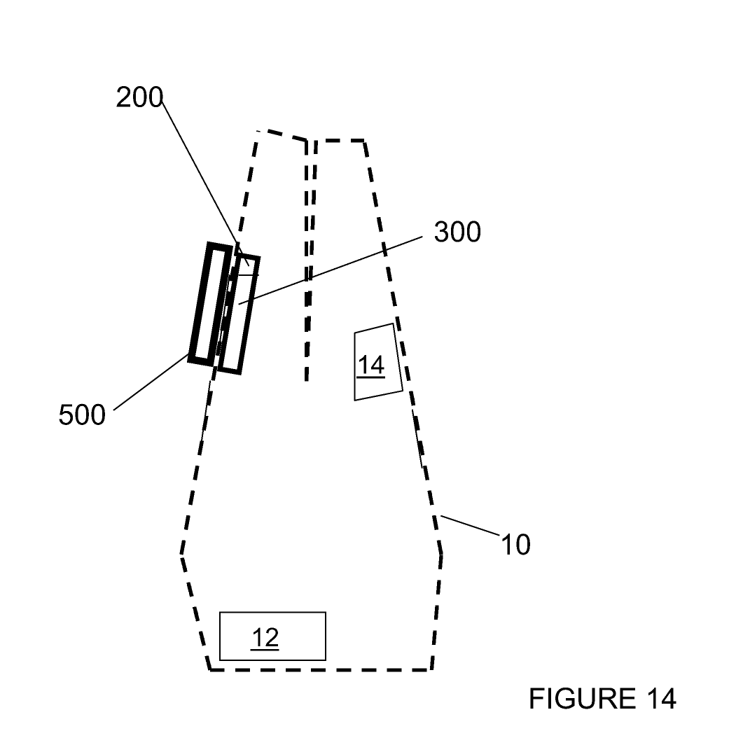

FIG. 4 is a view of the embodiment of FIG. 1 wherein the carrying container is in a closed state showing an activated exterior illumination source and an exterior actuator;

FIG. 5 is a view of another embodiment of a carrying container in an open state showing non-activated interior illumination source and an interior actuator;

FIG. 6 is a view of the embodiment of FIG. 5 wherein the carrying container is in an open state showing an activated interior illumination source and an interior actuator;

FIG. 7 illustrates an example of a magnetically activated actuator;

FIG. 8 illustrates an example of an electrical characteristic activated actuator;

FIG. 9 illustrates an example of a physically activated actuator;

FIG. 10 illustrates another example of an actuator in a non-activated state;

FIG. 11 illustrates another example of an actuator in an activated state; and

FIGS. 12-14 illustrate various states of the actuator of FIGS. 10 and 11 with respect to a carrying container.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

In the description below, a carrying container may have two access states, open or close, wherein the open access state allows a user to access the contents within the carrying container, and the closed access state precludes the user from accessing the contents within the carrying container.

As illustrated in FIG. 1, an opened carrying container 10 includes a power source 12, an interior illumination source 14, an exterior actuation switch 16, and an actuator 18.

The combination of the power source 12, the interior illumination source 14, and the exterior actuation switch 16 forms an electrical circuit which is normally open when the actuator 18 is not operatively engaged with the exterior actuation switch 16. The actual wiring between the elements of the circuit is not shown.

It is noted that the interior illumination source 14 is not providing any illumination although the carrying container 10 is in an open state because, as illustrated in FIG. 1, the actuator 18 is not operatively engaged with the exterior actuation switch 16.

To provide illumination, as illustrated in FIG. 2, the actuator 18 is operatively engaged with the exterior actuation switch 16. The operative engagement of the actuator 18 with the exterior actuation switch 16 causes the circuit, formed by the power source 12, the interior illumination source 14, and the exterior actuation switch 16, to become a closed circuit, thereby allowing power to flow from the power source 12 to the interior illumination source 14.

It is noted that the activation of the illumination is independent of the open state of the carrying container 10 or the act of opening the carrying container 10.

More specifically, as illustrated in FIG. 3, even though the carrying container 10 is in a closed state, the interior illumination source 14 is activated (turned ON) because the actuator 18 is operatively engaged with the exterior actuation switch 16.

It is noted, illustrated in FIG. 4, the carrying container 10 may include an exterior illumination source 24, an interior illumination source 14, and two exterior actuation switches 16 and 26. If the actuator 18 is operatively engaged with the exterior actuation switch 26, the exterior illumination source 24 is activated (turned ON), as illustrated in FIG. 4.

On the other hand, if the actuator 18 is operatively engaged with the exterior actuation switch 16, the exterior illumination source 14 is activated (turned ON) (not illustrated).

As illustrated in FIG. 5, an opened carrying container 10 includes a power source 12, an interior illumination source 14, an interior actuation switch 16, and an actuator 18.

The combination of the power source 12, the interior illumination source 14, and the interior actuation switch 16 forms an electrical circuit which is normally open when the actuator 18 is not operatively engaged with the interior actuation switch 16. The actual wiring between the elements of the circuit is not shown.

It is noted that the interior illumination source 14 is not providing any illumination although the carrying container 10 is in an open state because, as illustrated in FIG. 5, the actuator 18 is not operatively engaged with the interior actuation switch 16.

To provide illumination, as illustrated in FIG. 6, the actuator 18 is operatively engaged with the interior actuation switch 16. The operative engagement of the actuator 18 with the interior actuation switch 16 causes the circuit, formed by the power source 12, the interior illumination source 14, and the interior actuation switch 16, to become a closed circuit, thereby allowing power to flow from the power source 12 to the interior illumination source 14.

It is noted that the activation of the illumination is independent of the open state of the carrying container 10 or the act of opening the carrying container 10.

In the various embodiments illustrated in FIGS. 1-6, the power source 12 may be any conventional portable power source, such a rechargeable or non-rechargeable battery. The power source may include an interface to enable proper recharging, such as a universal serial bus port or electrical receptacle.

It is noted that the carrying container 10, in the various embodiments illustrated in FIGS. 1-6, may provide a mechanism for storing the power source 12 in a discreet manner as well as allowing easy replacement thereof.

Furthermore, it is noted that the illumination source 14, in the various embodiments illustrated in FIGS. 1-6, may be a light emitting diode light source, an electroluminescent panel, or other low power illumination source.

In addition, it is noted the actuator 18, in the various embodiments illustrated in FIGS. 1-6, may be a variety of items depending upon the actuation characteristics of the actuation switch. Examples of various actuation switches will be discussed below with respect to FIGS. 7-9.

FIG. 7 illustrates an actuation switch which is responsive to magnetic energy. More specifically, as illustrated in FIG. 7, the actuation switch 162 includes a magnetic switch 1621, such as a reed switch, which is normally open. Upon operative engagement with a magnetic actuator 182, the magnetic switch 1621 is closed and the illumination source is activated (turned ON).

It is noted that the actuation switch 162 may be constructed such that a mechanism is provided to keep the magnetic actuator 182 in operative engagement with the magnetic switch 1621 until the user removes the magnetic actuator 182. Upon removal of the magnetic actuator 182 from operative engagement with the magnetic switch 1621, the illumination source is de-activated (turned OFF).

FIG. 8 illustrates an actuation switch which is responsive to a change in electrical characteristics. More specifically, as illustrated in FIG. 8, the actuation switch 164 includes plates (1641 and 1643) which cause the circuit; formed by the power source, the illumination source, and the actuation switch; to be normally open.

Upon operative engagement with an electrically conductive actuator 184, the circuit becomes closed and the illumination source is activated (turned ON).

It is noted that the actuation switch 164 may be constructed such that a mechanism is provided to keep the electrically conductive actuator 184 in operative engagement with the plates (1641 and 1643) until the user removes the electrically conductive actuator 184. Upon removal of the electrically conductive actuator 184 from operative engagement with the plates (1641 and 1643), the illumination source is de-activated (turned OFF).

FIG. 9 illustrates an actuation switch which is responsive to a physical force. More specifically, as illustrated in FIG. 9, the actuation switch 166 includes a switching device 1661 and a trigger 1663.

The trigger 1663 is biased such that the switching device 1661 is normally open. Upon operative engagement with an actuator 186, the switching device 1661 is closed and the illumination source is activated (turned ON).

It is noted that the actuation switch 166 may be constructed such that a mechanism is provided to keep the actuator 186 in operative engagement with the trigger 1663 until the user removes the actuator 186. Upon removal of the actuator 186 from operative engagement with the trigger 1663, the illumination source is de-activated (turned OFF).

FIG. 10 illustrates an actuation switch which is responsive to a change in position of an actuator. More specifically, as illustrated in FIG. 10, the actuation switch includes an actuation sensor 200, a frame 300, a hinge 400, and a trigger/actuator 500.

As illustrated in FIG. 10, the actuation switch is in an open state because the location of the trigger/actuator 500 prevents the trigger/actuator 500 from triggering the sensor 200. In addition, the hinge 400 provides movement for the trigger/actuator 500 so that the trigger/actuator 500 can be placed in the open state, as illustrated in FIG. 10, or a closed state, as illustrated in FIG. 11. The frame 300 provides a substantially stationary base for hinge 400.

The frame 300 may be located on an external surface of a carrying container, on an interior surface of the carrying container, or within the carrying container shell or housing.

It is noted that the hinge 400 can be replaced with a sliding mechanism which enables the trigger/actuator 500 to be slid into the open state, as illustrated in FIG. 10, or slid into the closed state, as illustrated in FIG. 11.

For example, if the trigger/actuator 500 is a magnet and the sensor 200 is a reed switch or other magnetic sensor, the positioning of the trigger/actuator 500, as illustrated in FIG. 10, fails to provide a strong enough magnetic field for the sensor 200 to detect the presence of magnetic energy.

On the other hand, for example, if the trigger/actuator 500 is a solid object and the sensor 200 is a pressure sensor or switch, the positioning of the trigger/actuator 500, as illustrated in FIG. 10, fails to provide any pressure or physical presence for the sensor 200 to detect.

More specifically, if the sensor is touch sensitive, with respect to the trigger/actuator 500, the positioning of the trigger/actuator 500, as illustrated in FIG. 10, prevents the sensing of the touch.

Furthermore, for example, if the trigger/actuator 500 is electrically conductive and the sensor 200 is an electrical switch wherein the trigger/actuator 500 provides the means for closing the switch (closing the electrical circuit associated therewith), the positioning of the trigger/actuator 500, as illustrated in FIG. 10, fails to provide any electrical path to close the sensor 200.

FIG. 11 illustrates an actuation switch which is responsive to a change in position of an actuator. More specifically, as illustrated in FIG. 11, the actuation switch includes an actuation sensor 200, a frame 300, a hinge 400, and a trigger/actuator 500.

As illustrated in FIG. 11, the actuation switch is in a closed state because the location of the trigger/actuator 500 allows the trigger/actuator 500 to trigger the sensor 200. In addition, the hinge 400 provides movement for the trigger/actuator 500 so that the trigger/actuator 500 can be placed in the open state, as illustrated in FIG. 10, or a closed state, as illustrated in FIG. 11. The frame 300 provides a substantially stationary base for hinge 400.

The frame 300 may be located on an external surface of a carrying container, on an interior surface of the carrying container, or within the carrying container shell or housing.

It is noted that the hinge 400 can be replaced with a sliding mechanism which enables the trigger/actuator 500 to be slid into the open state, as illustrated in FIG. 10, or slid into the closed state, as illustrated in FIG. 11.

For example, if the trigger/actuator 500 is a magnet and the sensor 200 is a reed switch or other magnetic sensor, the positioning of the trigger/actuator 500, as illustrated in FIG. 11, provides a strong enough magnetic field for the sensor 200 to detect the presence of magnetic energy.

On the other hand, for example, if the trigger/actuator 500 is a solid object and the sensor 200 is a pressure sensor or switch, the positioning of the trigger/actuator 500, as illustrated in FIG. 11, provides enough pressure or physical presence for the sensor 200 to detect.

More specifically, if the sensor is touch sensitive, with respect to the trigger/actuator 500, the positioning of the trigger/actuator 500, as illustrated in FIG. 11, enables the sensing of the touch.

Furthermore, for example, if the trigger/actuator 500 is electrically conductive and the sensor 200 is an electrical switch wherein the trigger/actuator 500 provides the means for closing the switch (closing the electrical circuit associated therewith), the positioning of the trigger/actuator 500, as illustrated in FIG. 11, provides an electrical path to close the sensor 200.

FIG. 12 illustrates a carrying container 10 that includes an actuation switch which is responsive to a change in position of an actuator. More specifically, as illustrated in FIG. 12, the actuation switch of the carrying container 10 includes an actuation sensor 200, a frame 300, a trigger/actuator 500, a power source 12, and an interior illumination source 14.

As illustrated in FIG. 12, the actuation switch is in an open state because the location of the trigger/actuator 500 prevents the trigger/actuator 500 from triggering the sensor 200. The frame 300 provides a substantially stationary base for hinge 400.

The frame 300 may be located on an external surface of a carrying container, on an interior surface of the carrying container (as illustrated in FIG. 12), or within the carrying container shell or housing.

It is noted that the hinge 400 can be replaced with a sliding mechanism which enables the trigger/actuator 500 to be slid into the open state, as illustrated in FIG. 12, or slid into the closed state, as illustrated in FIG. 14.

For example, if the trigger/actuator 500 is a magnet and the sensor 200 is a reed switch or other magnetic sensor, the positioning of the trigger/actuator 500, as illustrated in FIG. 12, fails to provide a strong enough magnetic field for the sensor 200 to detect the presence of magnetic energy.

On the other hand, for example, if the trigger/actuator 500 is a solid object and the sensor 200 is a pressure sensor or switch, the positioning of the trigger/actuator 500, as illustrated in FIG. 12, fails to provide any pressure or physical presence for the sensor 200 to detect.

More specifically, if the sensor is touch sensitive, with respect to the trigger/actuator 500, the positioning of the trigger/actuator 500, as illustrated in FIG. 12, prevents the sensing of the touch.

Furthermore, for example, if the trigger/actuator 500 is electrically conductive and the sensor 200 is an electrical switch wherein the trigger/actuator 500 provides the means for closing the switch (closing the electrical circuit associated therewith), the positioning of the trigger/actuator 500, as illustrated in FIG. 12, fails to provide any electrical path to close the sensor 200.

FIG. 13 illustrates a carrying container 10 that includes an actuation switch which is responsive to a change in position of an actuator. More specifically, as illustrated in FIG. 13, the actuation switch of the carrying container 10 includes an actuation sensor 200, a frame 300, a trigger/actuator 500, a power source 12, and an interior illumination source 14.

As illustrated in FIG. 13, the actuation switch is in a transition state between the open state, as illustrated in FIG. 12, or the closed state, as illustrated in FIG. 13.

FIG. 14 illustrates a carrying container 10 that includes an actuation switch which is responsive to a change in position of an actuator. More specifically, as illustrated in FIG. 14, the actuation switch of the carrying container 10 includes an actuation sensor 200, a frame 300, a trigger/actuator 500, a power source 12, and an interior illumination source 14.

As illustrated in FIG. 14, the actuation switch is in a closed state because the location of the trigger/actuator 500 allows the trigger/actuator 500 to trigger the sensor 200. In addition, the hinge 400 provides movement for the trigger/actuator 500 so that the trigger/actuator 500 can be placed in the open state, as illustrated in FIG. 12, or the closed state, as illustrated in FIG. 14. The frame 300 provides a substantially stationary base for hinge 400.

The frame 300 may be located on an external surface of a carrying container, on an interior surface of the carrying container (as illustrated in FIG. 14), or within the carrying container shell or housing.

It is noted that the hinge 400 can be replaced with a sliding mechanism which enables the trigger/actuator 500 to be slid into the open state, as illustrated in FIG. 12, or slid into the closed state, as illustrated in FIG. 14.

For example, if the trigger/actuator 500 is a magnet and the sensor 200 is a reed switch or other magnetic sensor, the positioning of the trigger/actuator 500, as illustrated in FIG. 14, provides a strong enough magnetic field for the sensor 200 to detect the presence of magnetic energy.

On the other hand, for example, if the trigger/actuator 500 is a solid object and the sensor 200 is a pressure sensor or switch, the positioning of the trigger/actuator 500, as illustrated in FIG. 14, provides enough pressure or physical presence for the sensor 200 to detect.

More specifically, if the sensor is touch sensitive, with respect to the trigger/actuator 500, the positioning of the trigger/actuator 500, as illustrated in FIG. 14, enables the sensing of the touch.

Furthermore, for example, if the trigger/actuator 500 is electrically conductive and the sensor 200 is an electrical switch wherein the trigger/actuator 500 provides the means for closing the switch (closing the electrical circuit associated therewith), the positioning of the trigger/actuator 500, as illustrated in FIG. 14, provides an electrical path to close the sensor 200.

In the various embodiments described above, the circuit, which activates the illumination source, may also include a delay circuit, not illustrated, which will open the circuit (de-activate the illumination source) after a predetermined period of time notwithstanding the operative engagement of the actuator with the actuation switch.

It is further noted that the location of the interior illumination source may be on the side(s) of the carrying container, the bottom of the carrying container, the top of carrying container, or any combination thereof.

In addition, it is noted that the illumination system may not be attached to the carrying container so as to be removable, or the illumination system may be attached to the carrying container so as to be more integrated therewith.

Furthermore, it is noted that a portable version of the above described illumination system may be utilized by a user to provide safety illumination when the user is walking, jogging, rollerblading, riding a bicycle, etc. The above described illumination system may provided safety illumination during these activities so that an approaching vehicle can readily identify the user and take the appropriate actions to avoid a dangerous situation or harm to the user.

Moreover, it is noted that the actuator may be a fob or other small device. The actuator may be tethered or attached to the carrying container or may be untethered or unattached. The actuator may be ornamentally designed to coordinate with the appearance of the carrying container.

It is also noted that the power source may be a rechargeable power source.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for providing illumination in conjunction with a carrying container comprising:
an interior illumination source;
a power source;
an actuation device, operatively connected between said interior illumination source and said power source; and
an actuator to operatively engage said actuation device;
said interior illumination source being activated to provide illumination in response to said actuator being operatively engage with said actuation device and independent of an access state of the carrying container.

2. The system as claimed in claim 1, wherein said interior illumination source is a light emitting diode.

3. The system as claimed in claim 1, wherein said interior illumination source is an electroluminescence flexible panel.

4. The system as claimed in claim 1, further comprising:
an exterior illumination source; and
a second actuation device, operatively connected between said exterior illumination source and said power source;
said exterior illumination source being activated to provide illumination in response to said actuator being operatively engage with said second actuation device and independent of an access state of the carrying container.

5. The system as claimed in claim 1, wherein said actuator is a magnet.

6. The system as claimed in claim 1, wherein said actuator is electrically conductive.

7. A removable illumination unit for providing illumination in conjunction with a carrying container comprising:
a housing unit;
said housing unit including,
an interior illumination source,
a power source,
an actuation device, operatively connected between said interior illumination source and said power source, and
an actuator to operatively engage said actuation device;
said interior illumination source being activated to provide illumination in response to said actuator being operatively engage with said actuation device and independent of an access state of the carrying container.

8. The removable illumination unit as claimed in claim 7, wherein said interior illumination source is a light emitting diode.

9. The removable illumination unit as claimed in claim 7, wherein said interior illumination source is an electroluminescence flexible panel.

10. The removable illumination unit as claimed in claim 7, wherein said actuator is a magnet.

11. The removable illumination unit as claimed in claim 7, wherein said actuator is electrically conductive.

12. A system for providing illumination in conjunction with a carrying container comprising:
an interior illumination source;
a power source; and
an actuation switch, operatively connected between said interior illumination source and said power source;
said actuation switch including,
an actuation sensing device,
an actuator to operatively engage said actuation sensing device, and
a mechanism to provide relative movement between said actuation sensing device and said actuator such that said mechanism enables said actuator to be in a first position with respect to a position of said actuation sensing device and enables said actuator to be in a second position with respect to a position of said actuation sensing device;
said interior illumination source being activated to provide illumination in response to said actuator being in said first position with respect to the position of said actuation device;
said interior illumination source ceasing to provide illumination in response to said actuator being in said second position with respect to the position of said actuation device;
said interior illumination source being activated to provide illumination independent of an access state of the carrying container.

13. The system as claimed in claim 12, wherein said interior illumination source is a light emitting diode.

14. The system as claimed in claim 12, wherein said interior illumination source is an electroluminescence flexible panel.

15. The system as claimed in claim 12, further comprising:
an exterior illumination source; and
a second actuation device, operatively connected between said exterior illumination source and said power source;
said exterior illumination source being activated to provide illumination in response to said actuator being operatively engage with said second actuation device and independent of an access state of the carrying container.

16. The system as claimed in claim 12, wherein said actuator is a magnet.

17. The system as claimed in claim 12, wherein said actuator is electrically conductive.

18. The system as claimed in claim 12, wherein said mechanism is a hinge.

19. The system as claimed in claim 12, wherein said mechanism is a sliding device.

20. The system as claimed in claim 12, wherein said actuator is located on an exterior surface of the carrying container.
